(19) United States
(12) Patent Application Publication
(10) Pub. No.: US 2009/0092880 A1
(43) Pub. Date: Apr. 9, 2009

(54) METHOD FOR PREPARING HOMOGENEOUSLY SULFONATED POLY (ETHER ETHER KETONE) MEMBRANES BY THE CASTING METHOD USING ORGANIC SOLVENTS

(75) Inventors: Duk Joon Kim, Seoul (KR); Ngan Khanh Thi Do, Gyeonggi-do (KR); Eun Bum Cho, Seoul (KR)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: SUNGKYUNKWAN UNIVERSITY Foundation for Corporate Collaboration, Gyeonggi-do (KR)

(21) Appl. No.: 12/247,599

(22) Filed: Oct. 8, 2008

(30) Foreign Application Priority Data
Oct. 9, 2007 (KR) 10-2007-0101329

(51) Int. Cl. C08J 5/22; H01M 8/10

(52) U.S. Cl. 429/33

(57) ABSTRACT

The present invention relates to a method for preparing PEEK electrolyte membrane which is sulfonated homogeneously by employing organic solvent casting method. The method of preparing PEEK according to the present invention consists of steps of: dissolving the dried PEEK in methyl sulfonic acid solution; diluting the prepared solution with sulfuric acid for sulfonation; precipitating, filtering and washing the obtained material; dissolving the obtained material in organic solvents; and solidifying the obtained material. The methanol permeability of the membrane is lowered by 1/10 to that of Nafion, and the Young's modulus of the membrane is increased by about 10 times while the ion conductivity is maintained at a constant state by employing the present method. Further, the properties of the electrolyte membrane are affected by the type of organic solvent selected.

### BACKGROUND OF THE INVENTION

1. Field of the Invention

The present invention relates to a method for preparing PEEK proton electrolyte membranes by employing organic solvents.

2. Description of the Related Art

The most investigated field of the eco-friendly energy source for the next generation is the field of the fuel cell, and the problems regarding the technical aspect in technical fields should be solved for the development of a proton exchange electrolyte membrane which is an indispensable part for the actual driving of the fuel cell. Among the portable electronic equipments of the fuel cell applications, the direct methanol fuel cell (DMFC) is the most accessible and promising. The core technologies for the polymer electrolyte are roughly divided to the sub-fields relative to the conductivity, the stability and the thickness of the membrane, respectively, and the methanol crossover is the key problem for the direct methanol fuel cell. The most common proton exchange membrane for the direct methanol fuel cell is Nafion which is a perfluorosulfonic acid-type electrolyte membrane. While the perfluoro-type polymer electrolyte membrane provides higher conductivity and chemically stability, the performance of the membrane is lowered in a long time running because the membrane is thick and the degree of methanol permeability is relatively high, therefore the membrane also has problems in practical applications. Generally, the thinner membrane leads to the smaller over-voltage by the resistance, and the heavier equivalent weight provides the smaller ion conductivity. Therefore, the thinner polymer electrolyte having lighter equivalent weight is the preferable electrolyte membrane. However, a membrane having an excessively thin thickness raises not only the problem of mechanical strength, but also the problem of methanol crossover, which permits the permeation of gas for each pole of the cell from one pole to the other pole through the membrane, which leads to considerable loss of the performance of the fuel cell.

In this regard, the recent investigations have increasingly concerned with the polymer electrolyte composite membrane which has reduced thickness. Also, novel and cost effective membranes have been developed these days. The polymer electrolyte composite membranes have proper supports and mechanical properties comparable to Nafion membrane. Recently, W. L. Gore & Association has been actively investigating the development of the replacement for Nafion membrane, and has reported a polymer electrolyte membrane having Teflon support, which is come into the market, selling at high price, therefore not adequate for methanol fuel cell. Further, advanced countries, such as USA, Japan and European countries have carried out a number of investigations, however, resulting in no prominent outcome, and if any, the results would be tightly secured, therefore it is not easy to access the information. The most active investigations have been carried out in USA, for example PolyFuel, Inc. reported the performance of DMFC unit cell having excellent properties resulting from Z1 membrane which is developed in 2003, and Virginia Polytechnic Institute and State University and Los Alamos National Laboratory co-worked to develop polyethersulfone (PES), which showed good performance. In Japan, motor companies and electronics manufacturing companies have actively investigated, for example, Toshiba Corporation developed a fuel cell for proto-type laptop computer in 2002, which was in the news. The membrane for the mentioned fuel cell was comprised of inorganic materials, and these kinds of membranes also have been investigated in a number of motor companies, such as Toyota Corporation and Honda Motor Corporation. In Europe, mostly in German and Britain, the investigations have been actively carried out, for example Siemens AG, German has invested in the development of polymer electrolyte membrane, and Max-Plank Institute, German has investigated the development of polymer membrane with PEEK (Poly ether ether ketone). In Britain, Newcastle University has investigated mainly for catalyst and fuel cell system, as the hub of the investigations.

It is known that the prior Nafion membrane is relatively stable against lots of solvent, even strong bases, strong oxidizers and reducing agents such as hydrogen peroxide, chloride, hydrogen, oxygen and the like at temperature up to 125□. Wide water channels are provided by aggregation of hydrophilic domains in hydrophobic polymer in the presence of water which is generated from the driving of fuel cell, and it is known that such a channel is caused by high hydrophilic-hydrophobic minute phase separation associated with hydrophilic sulfonic acid groups and hydrophobic tetafluorobackbones. Consequently, methanol and water are easily transported across membranes through those channels. On that occasion, the methanol transported from anode to cathode causes the oxidation reaction to take place not only in anode but also in cathode, resulting in defects such as low performance of 35% in total, mixed potential, and loss of fuel. Further, the high water permeability lowers the performance of the cathode. Therefore, it is necessary to develop a novel membrane which is not expensive, and to solve the technical problems such as methanol crossover which is the representative defect of the pre-existing Nafion membrane, stability at high temperature and conductivity.

### SUMMARY OF THE INVENTION

The object of the present invention is to provide a method of preparing the electrolyte membrane for the direct methanol fuel cell which relieves the phenomenon of methanol crossover to the proper level and improves the ion conductivity.

To accomplish the subject, the present invention provides a method of preparing a PEEK (Poly Ether Ether Ketone) electrolyte membrane which is sulfonated homogeneously by employing organic solvent casting method.

The organic solvent may be selected from the group consisting of N,N-dimethyl formamide, N,N-dimethyl acetamide and 1-methyl-2-pyrrolidinone.

The PEEK polymer may have a weight average molecular weight between about 70,000 and 10,000.

The present invention provides a method of preparing an electrolyte membrane, comprising the steps of:

a) dissolving the sufficiently dried PEEK in methyl sulfonic acid solution;

b) diluting the prepared solution with sulfuric acid for sulfonation;

c) precipitating, filtering and washing the material obtained from the step b);

d) dissolving the obtained material from the step c) in organic solvents; and

e) solidifying the obtained solution from the step d).

The step a) may be carried out in a process that the PEEK is mixed in methyl sulfonic acid solution in an amount of 15˜25% by weight and dissolved with stirring.

The step b) may be carried out in a process that 90˜100% aqueous sulfuric acid solution is added to the prepared solution from the step a) in an amount of 5˜10 times by volume with respect to that of methyl sulfonic acid, and then the sulfonation is carried out under nitrogen atmosphere.

The step c) may be carried out in a process that the obtained sPEEK (i.e., sulfonated PEEK) from the step b) is precipitated in an excess amount of water of 0□ and the precipitated are filtered and washed, and the step c) further comprises a process that the obtained material is dried at room temperature, the dried material is subjected to grinding and the ground particles are maintained at 60˜100□ for 24 hours.

Also, the present invention provides a sPEEK proton electrolyte membrane being prepared by the above-mentioned method.

These and other features, aspects, and advantages of the present invention will become better understood with regard to the following description, appended claims, and accompanying drawings or may be learned by practice of the invention.

### BRIEF DESCRIPTION OF THE DRAWINGS

FIG. 1 depicts the variation of the degree of sulfonation (DS) and the ion exchange capacity (IEC) for DMF as ▾ and for DMAC as , respectively during the sulfonation of PEEK prepared as in the Examples of the present invention.

FIG. 2 depicts the methanol permeability at room temperature of the homo-sPEEK electrolyte membranes which were prepared with N,N-dimethyl formamide and 1-methyl-2-pyrrolidinone solvents described as in the Examples of the present invention.

FIG. 3 depicts the proton conductivity at room temperature of the homo-sPEEK electrolyte membranes which were prepared with N,N-dimethyl formamide, N,N-dimethyl acetamide, and 1-methyl-2-pyrrolidinone solvents described as in the Examples of the present invention.

FIG. 4 depicts the tensile strength of the hydrated homo-sPEEK electrolyte membranes which were prepared with N,N-dimethyl formamide, N,N-dimethyl acetamide, and 1-methyl-2-pyrrolidinone solvents described as in the Examples of the present invention.

FIG. 5 depicts the Young's moduli of the hydrated homo-sPEEK electrolyte membranes which were prepared with N,N-dimethyl formamide, N,N-dimethyl acetamide, and 1-methyl-2-pyrrolidinone solvents described as in the Examples of the present invention.

FIG. 6 depicts the characteristic factor (=ion conductivity/methanol permeability) of the homo-sPEEK electrolyte membrane which were prepared with N,N-dimethyl formamide, N,N-dimethyl acetamide, and 1-methyl-2-pyrrolidinone solvents described as in the Examples of the present invention.

### DETAILED DESCRIPTION OF THE INVENTION

A sulfonated PEEK (hereafter, it is referred to sPEEK) has high mechanical properties, low methanol permeability and proper ion conductivity. Also, the sPEEK allows casting from organic solution, offering more convenient and less expensive membrane fabrication process than perfluorosulfonic acid membrane such as Nafion does. The sPEEK membrane is prepared by using solvents such as N,N-dimethyl formamide (DMF), N,N-dimethyl acetamide (DMAC) and/or 1-methyl-2-pyrrolidinone (NMP), which affect membrane property, for example the interaction with the sulfonic acid groups of sPEEK decreases the number of proton and the ion conductivity.

When sulfuric acid solution is used for the both purposes of dissolution of polymer and sulfonation, the sulfonate groups are placed non-homogeneously inside the polymer chains [See, Jin, X., Bishop, M. T., Ellis, T. S. and Karasz, F. E. Br. Polym. J. 1985, 17, 4.]. Therefore, the present invention provides a method for preparing sPEEK which is sulfonated by a sulfonic acid after dissolving PEEK in methyl sulfonic acid (MSA), and it was found that the prepared membrane would possibly substitute for Nafion membrane according to investigations of the structure and morphology, water uptake, methanol permeability, ion conductivity and mechanical strength of the membranes which are prepared with a few different solvent.

A method for preparing an sPEEK membrane according to the present invention may comprise steps of:

a) dissolving the sufficiently dried PEEK in methyl sulfonic acid solution;

b) diluting the prepared solution with sulfuric acid for sulfonation;

c) precipitating, filtering and washing the material obtained from the step b);

d) dissolving the obtained material from the step c) in organic solvents; and

e) solidifying the obtained material from the step d) by placing it on a plate at proper temperature in vacuum for a few days.

The step a) may be carried out in a process that the PEEK is dissolved in methyl sulfonic acid solution in an amount of 15˜25% by weight and the solution is vigorously stirred with magnetic stirrer for 24 hours.

The step b) is carried out in a proves that 90˜100% aqueous sulfuric acid solution is added in an amount of 5˜10 times by volume with respect to that of methyl sulfonic acid to the stirred prepared PEEK solution, and the solution would be maintained under nitrogen atmosphere for at most 220 hours.

The step c) may be carried out in a process that the sPEEK is precipitated with excess amount of water of 0□ for a proper while, followed by washing with distilled water for several times, and the resultant is dried at room temperature for 24 hours. The dried material was ground in a mortar and dried in vacuum oven at 60˜100□ for a day in order to obtain final products.

The dried sPEEK particles having different sulfonation depending on the retention time in step b) are dissolved in organic solvent in the amount of 3˜5% by weight.

The examples of the organic solvent may include, but not limited to, N,N-dimethyl formamide, N,N-dimethyl acetamide and 1-methyl-2-pyrrolidinone. Also, based on the stirring temperature determined depending on the degree of sulfonation, the solution comprising sPEEK particles of which sulfonation degree is over 80% is stirred at room temperature, the solution comprising sPEEK particles of which sulfonation degree is 60˜70% is stirred at about 60□, and the solution comprising sPEEK particles of which sulfonation degree is under 50% is stirred at about 100□, with magnetic stirrer, respectively.

Each of the polymer solution in the step e) is to be solidified by placing it on a glass plate at 25˜140□ in vacuum for a few days, and the sPEEK membrane peeled off from the glass plate by using distilled water is washed with distilled water and stored in the bottle of distilled water before analysis.

The weight average molecular weight of the PEEK polymer used for the present invention is not limited, but the range 70,000˜100,000 is preferable regarding the solubility of organic solvent and the mechanical strength of the final membrane.

The sPEEK membrane provided by the solvent casting method has the methanol crossover of 9.44×10⁻⁸˜1.86×10⁻⁶ cm⁻²/s and the proton conductivity of 0.011˜0.37 S/cm. Regarding the characteristic factor of the ion conductivity property to the mechanical strength and the methanol permeability, the DMAC-sPEEK membrane was most excellent for direct methanol fuel cell application, resulting from the methanol permeability inhibition which is more effective than that of the ion conductivity.

The method for preparing a sulfonated PEEK electrolyte membrane according to the present invention provides the sulfonated PEEK which has low methanol permeability under 4×10⁻⁷ cm²/s and proton conductivity of at least 0.15 S/cm in easier way.

Further, the present invention permits the control of the properties of the electrolyte membrane by selection of organic solvent.

The invention may be better understood by reference to the following examples which are intended for the purpose of illustration and are not to be construed as in any way limiting the scope of the present invention, which is defined in the claims appended hereto.

### EXAMPLES

### Example 1

### Homogeneous Sulfonation of PEEK

The PEEK particles (Victrex PLC) having weight average molecular weight of 70,000˜100,000 were placed in a vacuum oven, and dried at 100□ for 24 hours. 20 g of the PEEK particle was dissolved in methyl sulfonic acid in total volume of 100 mL and placed under vigorous stirring for 24 hours. The prepared stirred solution and 800 mL of 97% aqueous sulfuric acid solution were placed in an Erlenmeyer flask and diluted under nitrogen atmosphere. The state was maintained for at most 220 hours, and some sPEEK having various sulfonation degree depending on the retention time were obtained. The obtained sPEEK were precipitated with excess amount of water of 0□. The precipitated was filtered, washed repeatedly with distilled water, and dried at room temperature for 24 hours. The dried material was ground in a mortar and dried in vacuum oven at 60˜100□ for a day in order to obtain final products.

### Example 2

### Preparation of Electrolyte Membrane

The dried sPEEK particles having different sulfonation degree of 48%, 60%, 68% and 83% prepared in Example 1 were dissolved in each of N,N-dimethyl formamide, N,N-dimethyl acetamide and 1-methyl-2-pyrrolidinone in the amount of 3˜5% by weight, respectively. Each solution was magnetically stirred at different temperatures depending on the sulfonation degree of sPEEK. The solution comprising sPEEK particles of which sulfonation degree was 83% was stirred at room temperature, but the solution comprising sPEEK particles of which sulfonation degree was 60˜70% around 60□, and the solution comprising sPEEK particles of which sulfonation degree was 48% around 100□ with magnetic stirrer, respectively. Each of the polymer solution was casted on a glass plate at 25˜140□ in vacuum for a few days. The sPEEK membrane was peeled off from the glass plates with distilled water. It was rinsed in distilled water, and stored in a distilled water bottle until analyzed.

### Example 3

### Determination of Degree of Sulfonation (DS) and Ion Exchange Capacity (IEC)

The degree of sulfonation (DS) was determined by back-titration method. 0.1 g of the sPEEK particles were placed in 20 mL of 0.05N sodium hydroxide, and kept for 3 days, and the resultant were titrated with 0.05M hydrochloric acid solution using pH meter.

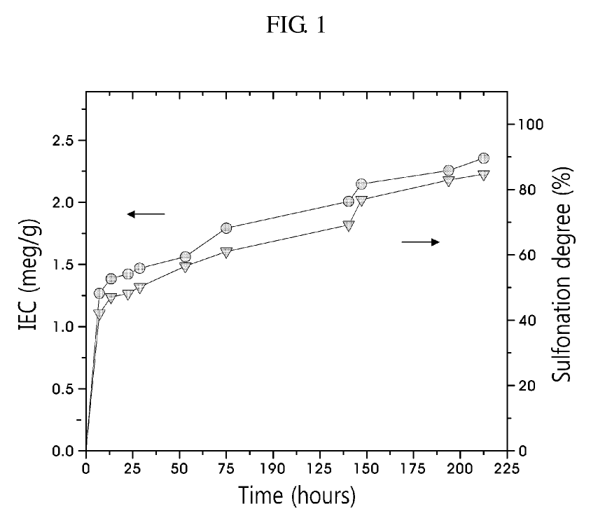

FIG. 1 depicts the variation of the degree of sulfonation (DS) and the ion exchange capacity (IEC) on the elapsed time. The peak DS of 83% and the peak IEC of 2.4 meq/g were obtained up to 225 hours.

### Example 4

### Determination of Water Uptake

The membranes dried in desiccators at room temperature for a week were weighed, and soaked in distilled water, followed by being maintained at room temperature for 48 hours. The membranes were periodically weighed after prompt removal of water from their surface, and the water uptake was calculated by the following equation:

% water uptake=(W_{wet}−W_{dry})×100/W_{dry}

wherein W_{wet} and W_{dry} indicates the water uptake of wet and dry membranes, respectively.

### Example 5

### Determination of Methanol Permeability

A gas diffusion cell was used for the determination of methanol permeability. 50 mL of 2M aqueous methanol solution was placed on one side of the cell, and 50 mL of the distilled water on the other side. To ensure uniform concentration, a magnetic stirrer bar was placed in each compartment. The methanol concentration in the water compartment was continuously monitored by detector (RI750F, Young-Lin Instrument Co., Ltd., Korea) at room temperature, and a series of data was obtained.

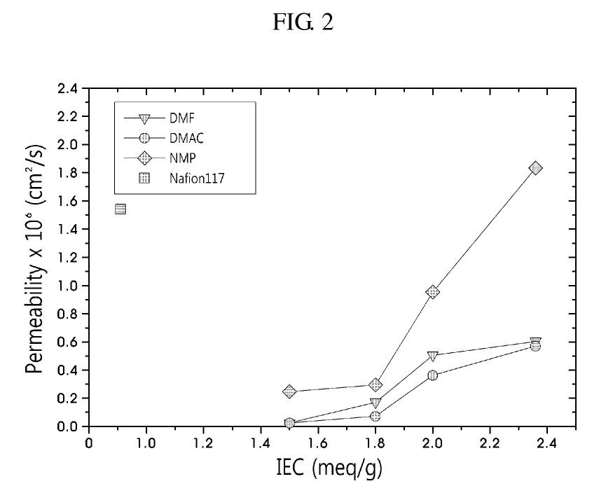

FIG. 2 depicts the variation of the methanol permeability against the solvent utilized to the ion exchange capacity of the obtained membranes. When using N,N-dimethyl formamide and N,N-dimethyl acetamide solvents, the minimum value of 9.4×10⁻⁸ cm²/s for the ion exchange capacity of 1.5 was detected, and the low value of 6×10⁻⁷ cm²/s for the ion exchange capacity of 2.4 was detected.

### Example 6

### Determination of Proton-Conductivity

Before determining the ion conductivity of the hydrated electrolyte membrane, the membranes were stored in 1M aqueous sulfuric acid solution for 2 days. The electrochemical instrumentation (Pastat 2263, Princeton Applied Research,. Oak Ridge, USA) was used to detect the resistance over a frequency range of 1˜10⁵ Hz at the voltage of 50 mV across the membrane. The ion conductivity (σ) of the sample at the cross section was calculated from the impidance data, using the relationship: σ=t/RA, wherein t (cm) indicates the thickness of the sample membrane and A (cm²) indicates the face area of the membrane, and the resistance R (Ω) is derived from the low intersect of the high frequency semicircle on a complex impedance plane with the Re (Z) axis.

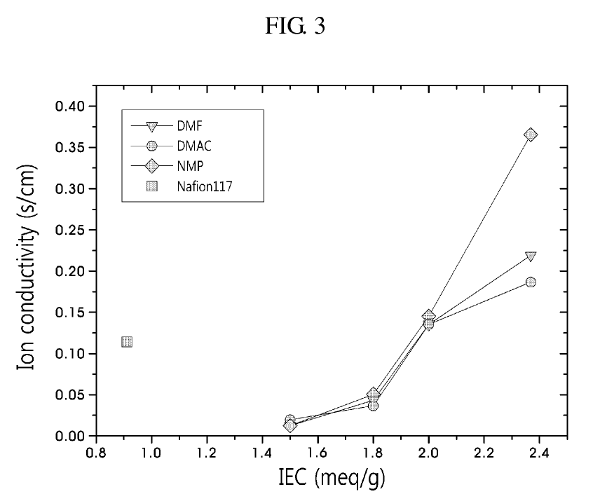

FIG. 3 depicts the variation of the proton conductivity to the ion exchange capacity of the obtained membrane and the solvents used. In the case that the ion exchange capacity was 2.0 or less, the present membranes performed 0.15 S/cm of ion exchange capacity which is similar to that of Nafion for all kinds of solvent utilized. However, when the ion exchange capacity was 2.4, the present membrane performed an increased ion exchange capacity, for example 0.37 for the solvent 1-methyl-2-pyrrolidinone and 0.22 for the solvent N,N-dimethyl formamide, respectively

### Example 7

### Determination of Mechanical Property

The tensile strength and the Young's moduli which were related to the mechanical strength of the present electrolyte membrane were determined with the UTM (model 5565, Lloyd). Samples in width of 20 mm and in length of 500 mm were tested with a 250 N load cell pulled at 50 (mm/min) within 21 cm gauge length.

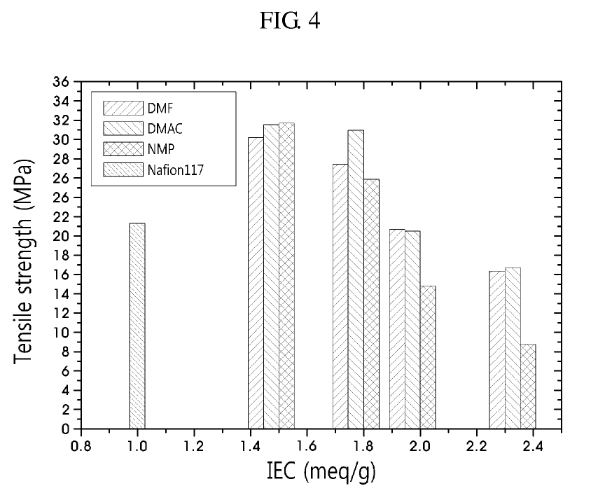

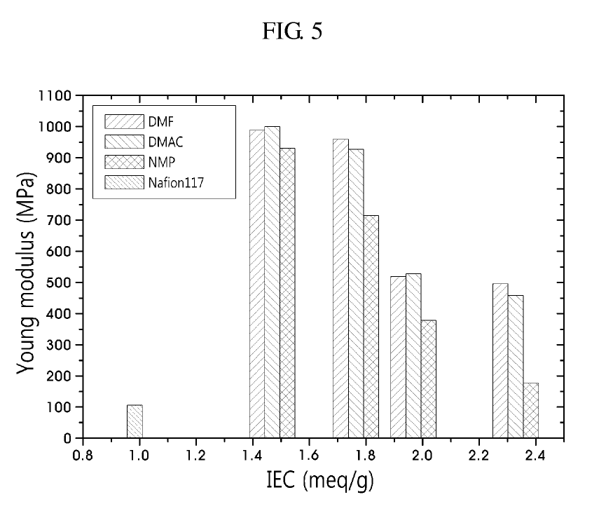

FIG. 4 and FIG. 5 depict the variation of the tensile strength and the Young's moduli to the ion exchange capacity and the solvent utilized, respectively. The mechanical properties tend to be decreased as the ion exchange capacity increases, however, the properties of the electrolyte membranes prepared using N,N-dimethyl formamide and N,N-dimethyl acetamide solvents showed relatively good properties rather than those of Nafion, until the ion exchange capacity reached 2.0.

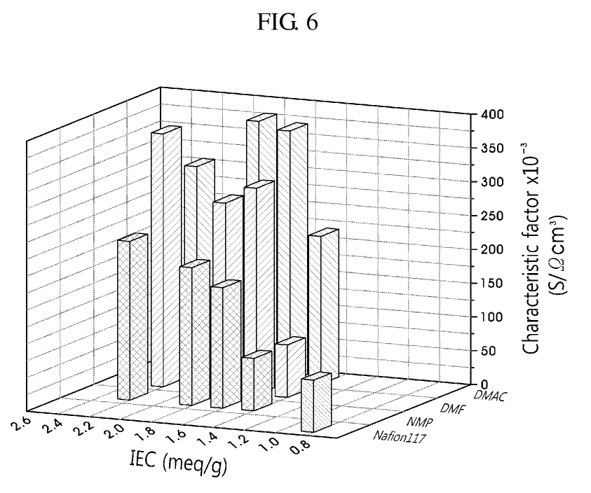

As seen the result from the examples, the present invention provides a successful electrolyte membrane preparation method which employs PEEK polymer material in place of the pre-existed Nafion for sulfonation and utilizes various organic solvents. Further, in the light that the control of the methanol permeability is the most important for the direct methanol fuel cell, the DMAC-sPEEK membrane having an ion exchange capacity of 2.0 displayed the most excellent performance in the application of the direct methanol fuel cell. The result is confirmed in FIG. 6 which depicts the data of the characteristic factor of the ion conductivity to the methanol permeability. Generally, the membrane of excessively high sulfonation degree has higher methanol permeability and lower mechanical properties caused by excessive expansion by the action of moisture, while the membrane of low sulfonation degree performs insufficient proton conductivity.

The method of preparing a PEEK electrolyte membrane according to the present invention permits the control of the properties of the electrolyte membrane by selecting organic solvents and provides decreased methanol permeability by 1/10 compared with that of Nafion. Further, the present invention provides the electrolyte membrane of which Yong's Modulus is increased by about 10 times, and of which ion conductivity is maintained in a constant level at the same time. Therefore, the electrolyte membrane of the present invention is a promising alternative membrane which solves both the cost problem of the existed Nafion and the performance degradation caused by methanol crossover, in the light of the industrial applicability.

The present invention was illustrated in said preferable examples, however it should be understood that a number of various modifications and substitutions could be made by those skilled in the art without departing from the spirit and scope of the invention as defined in the following claims.

1. A method of preparing a PEEK (Poly Ether Ether Ketone) electrolyte membrane which is sulfonated homogeneously by employing an organic solvent casting method.

2. The method according to claim 1, wherein the organic solvent is selected from the group consisting of N,N-dimethyl formamide, N,N-dimethyl acetamide and 1-methyl-2-pyrrolidinone.

3. The method according to claim 1, wherein the PEEK polymer has a weight average molecular weight between about 70,000 and 100,000.

4. A method of preparing an electrolyte membrane, comprising the steps of:
a) dissolving dried PEEK (Poly Ether Ether Ketone) in methyl sulfonic acid solution;
b) diluting the prepared solution with sulfuric acid for sulfonation;
c) precipitating, filtering and washing the material obtained from step b);
d) dissolving the obtained material from step c) in organic solvents; and
e) solidifying the obtained solution from step d).

5. The method of preparing an electrolyte membrane according to claim 4, wherein step a) is carried out in a process in which the PEEK is mixed in methyl sulfonic acid solution in an amount of 15˜25% by weight and dissolved by stirring.

6. The method of preparing an electrolyte membrane according to claim 4, wherein step b) is carried out in a process in which 90˜100% aqueous sulfuric acid solution is added to the prepared solution from step a) in an amount of 5˜10 times by volume with respect to that of methyl sulfonic acid, and then the sulfonation is carried out under nitrogen atmosphere.

7. The method of preparing electrode membrane according to claim 4, wherein step c) is carried out in a process in which the obtained sPEEK (i.e., sulfonated PEEK) from step b) is precipitated in an excess amount of water of 0° C. and the precipitated product is filtered and washed, and step c) further comprises a process in which the obtained material is dried at room temperature, the dried material is subjected to grinding and the ground particles are maintained at 60˜100° C. for 24 hours.

8. A sPEEK (sulfonated Poly Ether Ether Ketone) proton electrolyte membrane being prepared by a method of preparing a PEEK (Poly Ether Ether Ketone) electrolyte membrane which is sulfonated homogeneously by employing an organic solvent casting method.

9. A sPEEK (sulfonated Poly Ether Ether Ketone) proton electrolyte membrane being prepared by a method of preparing an electrolyte membrane, the method comprising the steps of:
a) dissolving dried PEEK (Poly Ether Ether Ketone) in methyl sulfonic acid solution;
b) diluting the prepared solution with sulfuric acid for sulfonation;
c) precipitating, filtering and washing the material obtained from step b);
d) dissolving the obtained material from step c) in organic solvents; and
e) solidifying the obtained solution from step d).
